(19) United States
(12) Patent Application Publication
(10) Pub. No.: US 2013/0008788 A1
(43) Pub. Date: Jan. 10, 2013

(54) METHOD AND APPARATUS FOR ELECTRICAL TREATMENT, AND ANODE USED FOR THE SAME

(75) Inventors: Tooru Masaoka, Shinjuku-ku (JP); Takaaki Masui, Shinjuku-ku (JP)

(73) Assignee: KURITA WATER INDUSTRIES LTD., Tokyo (JP)

(21) Appl. No.: 13/519,254

(22) PCT Filed: Dec. 21, 2010
(86) PCT No.: PCT/JP2010/072956

§ 371 Date: Sep. 18, 2012

(30) Foreign Application Priority Data
Dec. 28, 2009 (JP) 2009-298233

(51) Int. Cl. C25B 11/02; B01D 57/02

(52) U.S. Cl. 204/450; 204/600

(57) ABSTRACT

To provide an anode which can prevent scale from being deposited on the contact surface of the anode with materials to be processed, an apparatus including the anode for electrical treatment, and a method for electrical treatment using the apparatus. An endless conveyor belt 1 formed using filter cloth is provided between rollers 2 and 3 so as to be able to rotate over a cathode plate 4 formed using a porous plate. Anode units 21 to 25 are arranged in the carrying direction of the conveyor belt 1. A coating 7 is provided on the lower surface of an anode plate 33 of each of the anode units and is in the form of a porous synthetic resin plate or a porous glass filter having at least any one of water permeability and electric conductivity.

### FIELD OF INVENTION

The present invention relates to a method and apparatus for electrical treatment, such as electrolysis of water, electrodialysis, and electro-osmotic dewatering to dewater hydrated materials, and relates to an anode used for the apparatus.

### BACKGROUND OF INVENTION

Electro-osmotic dewatering is well known as a technique to dewater hydrated materials such as sludge produced in biotreatment of wastewater (Patent Literatures 1 to 3). The electro-osmotic dewatering involves passing an electric current through hydrated materials to be processed and applying pressure for dewatering while attracting negatively charged sludge to an anode and transferring pore water contained in the sludge to a cathode. Compared with mechanical dewatering, the electro-osmotic dewatering thus provides high dewatering efficiency and can further reduce the moisture content of sludge.

Electro-osmotic dewatering apparatus disclosed in Patent Literature 1 enables electro-osmotic dewatering of sludge between a rotating endless lower filter belt (cathode) and a rotating endless upper press belt (anode).

Electro-osmotic dewatering apparatus disclosed in Patent Literature 2 includes an electrode drum as an anode aside from an upper press belt, and the electrode drum applies pressure between the upper and lower belts.

Electro-osmotic dewatering apparatus disclosed in Patent Literature 3 involves supplying sludge onto a rotating endless conveyor belt, compressively holding hydrated materials between a cathode plate underlying the conveyor belt and anode units overlying the conveyor belt, and passing an electric current through the hydrated materials for electro-osmotic dewatering. A plurality of anode units are located in the direction of movement of the conveyor belt. A planar anode plate is provided on the bottom of each of the anode units. The anode plate is configured so as to be able to be pressed down by an air cylinder and raised by a spring. The conveyor carries the hydrated materials by a single span (distance between the individual anode units) in a state in which the anode plate is raised.

As disclosed in Patent Literature 2, the anode of the electro-osmotic dewatering apparatus includes a substrate made from highly corrosion resistant metal, such as titanium, and a thin coating formed on the surface of the substrate and made from noble metal materials such as platinum and ruthenium oxide. In the electro-osmotic dewatering apparatus, negatively charged fine particles may move to the anode and cause scale to be deposited on the surface of the anode. In the case where the deposit is an insulator, the surface potential of the anode increases with the result that ability to pass an electric current decreases, leading to the decrease in dewatering performance.

Patent Literature 2 discloses a method for inhibiting formation of the deposit on the anode, which involves spreading weakly alkaline aqueous solution on the surface of the anode for continuous cleaning.

However, the spreading of weakly alkaline aqueous solution can not be employed for equipment including an anode constantly facing downward as in disclosed in Patent Literature 3 while the weakly alkaline aqueous solution can be applied to the anode having the structure of a rotating drum as in disclosed in Patent Literature 2 because the anode turns up during the rotation.

The weakly alkaline aqueous solution is constantly spread and thus get mixed with sludge with the result that the moisture content of the sludge increases, leading to the decrease in dewatering performance.

The interface between the metallic substrate of the anode and the noble metal coating deteriorates in the presence of alkali, resulting in easy removal of the noble metal coating. Constantly spreading the weakly alkaline aqueous solution may therefore promote the deterioration of the anode.

Patent Literature 4 discloses a method for manufacturing electrolytic copper foil or reactivating an electrolytic electrode, such as copper plating, and the method involves immersing an electrode having deposit of scale into an aqueous solution containing nitric acid and hydrogen peroxide and removing the deposit formed on the electrode by high-pressure water washing. This method is effective for removing the scale but is not effective for preventing the deposition of scale.

### PATENT LITERATURES

Literature 1: Japanese Patent Publication 1-189311A
Literature 2: Japanese Patent Publication 6-154797A
Literature 3: International Publication WO2007/143840
Literature 4: Japanese Patent Publication 2008-150700A

### OBJECT AND SUMMARY OF INVENTION

It is an object of the invention to provide an anode which prevents scale from being deposited on a surface thereof which contacts materials to be processed, an apparatus including the anode for electrical treatment, and a method for electrical treatment using the apparatus.

A first aspect provides an anode used for an apparatus for electrical treatment, the apparatus having the anode and a cathode facing the anode between which an object is treated by passing an electric current therethrough. The anode has a surface which the object contacts, and the surface is coated by a coating consisting of a material having at least one of water permeability and electric conductivity.

A second aspect provides the anode according to the first aspect, wherein the material consisting the coating further has acid resistance and thermal resistance.

A third aspect provides the anode according to the second aspect, wherein the coating is one of woven fabric and non-woven fabric formed using fibers.

A fourth aspect provides the anode according to the second aspect, wherein the fibers are glass fibers, and the coating has a thickness in the range from 0.01 to 10 mm.

A fifth aspect provides the anode according to the second aspect, wherein the coating is one of porous synthetic resin and porous glass.

A sixth aspect provides the anode according to the first aspect, wherein the material consisting the coating is a material charged to a negative surface potential.

A seventh aspect provides an apparatus for electrical treatment having an anode, and a cathode facing the anode between which an object is treated by passing an electric current therethrough. The anode is any one of the aspects 1 to 6.

An eighth aspect provides the apparatus according to the seventh aspect, wherein the electrical treatment is electro-osmotic dewatering.

A ninth aspect provides a method for electrical treatment using the apparatus according to the seventh aspect. The method has a step of placing an object to be treated consisting of one of liquid material and hydrated material between the anode and the cathode, and a step of applying a voltage between the anode and the cathode to pass an electric current thorough the object.

### Advantageous Effects of Invention

The anode according to an aspect of the invention has the surface that contacts an object to be treated and that is covered with the coating formed using a material having at least any one of water permeability and electric conductivity. The coating having electric conductivity prevents particulate, anionic, or cationic scale components contained in the materials to be processed from moving toward the surface of the anode and being deposited thereon.

In the case where the coating has water permeability, since the coating contains water, the coating comes to have electric conductivity even though the material of the coating does not have electric conductivity. The scale components are prevented from moving toward the surface of the anode and being deposited thereon. The coating having water permeability is preferably woven fabric or non-woven fabric formed using fibers.

The coating is preferably formed using a material having thermal resistance and acid resistance, such as porous synthetic resins, for example, PTFE filter, or porous glass, for instance, a glass filter.

The coating formed using a material charged to a positive surface potential adsorbs negatively charged particulate or anionic scale components and avoids cationic scale components. The movement of cationic scale components toward the anode are therefore prevented or suppressed. The scale can be accordingly prevented from being deposited on the anode.

The coating formed using a material charged to a negative surface potential avoids negatively charged particulate or anionic scale components. The coating adsorbs cationic scale components, thereby preventing or suppressing the movement of the negatively charged particulate or anionic scale components toward the anode. The scale can be accordingly prevented from being deposited on the anode.

The coating having a multilayered structure of a material charged to a negative surface potential and a material charged to a positive surface potential adsorbs or avoids negatively charged particulate, cationic, or anionic scale components, thereby preventing or suppressing the movement of the scale components toward the anode. The scale can be accordingly prevented from being deposited on the anode.

### BRIEF DESCRIPTION OF DRAWINGS

FIG. 1a is a vertical cross-sectional view schematically illustrating an embodiment of an electro-osmotic dewatering apparatus.

FIG. 1b is a cross-sectional view illustrating the electro-osmotic dewatering apparatus taken along the line 1b-1b in FIG. 1a.

FIG. 2 is a vertical cross-sectional view schematically illustrating the embodiment of an electro-osmotic dewatering apparatus.

FIG. 3 is a vertical cross-sectional view schematically illustrating another embodiment of an electro-osmotic dewatering apparatus.

FIG. 4 is a cross-sectional view illustrating an example of an anode.

### DESCRIPTION OF EMBODIMENTS

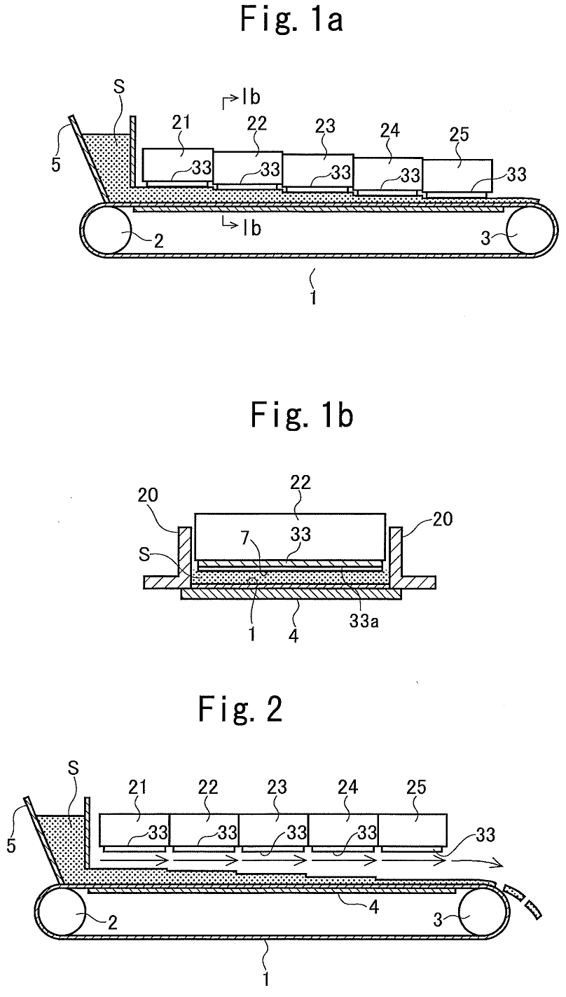

Embodiments are hereinafter described with reference to the attached drawings. FIGS. 1a and 2 are vertical cross-sectional views each illustrating an embodiment of an electro-osmotic dewatering apparatus in the longitudinal direction (direction in which a belt rotates). FIG. 1b is a cross-sectional view illustrating the electro-osmotic dewatering apparatus taken along the line 1b-1b in FIG. 1a. In addition, FIGS. 1a and 1b each illustrate a dewatering process, and FIG. 2 illustrates a belt-feeding process in the electro-osmotic dewatering apparatus.

An endless conveyor belt 1 formed using filter cloth is rotatably provided between rollers 2 and 3.

The conveyor belt 1 carries sludge placed on the upper side thereof and returns through the lower side. A planar cathode 4 is disposed on the under surface of the carrying side of the conveyor belt 1. The cathode 4 is formed using conductive materials, such as metal, in the shape of a plate and has a plurality of pores that vertically penetrate the cathode 4. The cathode 4 extends from the vicinity of the roller 2 to the vicinity of the roller 3.

A hopper 5 is provided on the upper surface of the conveyor belt 1 on the upstream side of the carrying direction to supply hydrated materials to be processed (sludge S in this embodiment).

Anode units 21, 22, 23, 24, and 25 are provided above the carrying portion of the conveyor belt 1. With reference to FIG. 1b, side wall plates 20 are vertically provided on the two sides of the carrying portion of the conveyor belt 1 so as to prevent the sludge on the conveyor belt 1 from being ejected to the side direction. The anode units 21 to 25 are disposed between the side wall plates 20.

In this embodiment, although the five anode units are provided in the carrying direction of the conveyor belt, the invention should not be limited to this configuration. The anode units may be provided normally in the number of approximately two to five in the carrying direction of the conveyor belt.

Each of the anode units 21 to 25 includes an anode plate 33 attached to the bottom thereof and an air cylinder (not illustrated) which vertically reciprocates. The air cylinder has the upper end fixed to a beam (not illustrated) as a body of the electro-osmotic dewatering apparatus and has the lower end attached to the anode plate 33. The anode plate 33 moves downward as a result of supplying air into the air cylinder. The anode plate 33 moves upward as a result of discharging the air from the air cylinder.

The anode plate 33 is formed as a result of coating a surface of a substrate made from, for example, titanium with noble metal, such as platinum and ruthenium oxide. The anode plate 33 has the lower surface 33a (surface which contacts the sludge S), and a coating 7 is formed using materials having at least any one of water permeability and electric conductivity on the lower surface 33a. Preferred example of the material used for the coating will be hereinafter described.

A direct current is supplied from a direct-current power source (not illustrated) to the anode plate 33 of each of the anode units 21 to 25.

The electro-osmotic dewatering apparatus having such a configuration dewaters the sludge as follows: transporting the sludge S supplied into the hopper 5 onto the conveyor belt 1, feeding air into the air cylinders of the anode units 21 to 25 while supplying a direct current to the anode units 21 to 25, and pressing the sludge from above by the anode plates 33 of the anode units 21 to 25.

A positive voltage is applied to the anode units 21 to 25, and a negative voltage is applied to the cathode plate 4. Although the same voltage is preferably applied to the anode units 21 to 25 in view of easy operation management of the apparatus, the voltage to be applied may be increased or decreased as the anode units are positioned to the downstream side. The supplying of an electric current may be controlled such that the electric current at the same level passes through the anode units.

Air at the same pressure level may be supplied to the air cylinders of the anode units 21 to 25, or the pressure of the air to be supplied may be increased or decreased as the anode units are positioned to the downstream side.

The anode plates 33 of the cathode units 21 to 25 press the sludge while an electric current passes between the anode units 21 to 25 and the cathode plate 4, thereby conducting the electro-osmotic dewatering of the sludge. Filtrate produced by the dewatering penetrates the conveyor belt 1 and falls onto a tray (not illustrated) through the pores of the cathode plate 4. The filtrate is then transported to wastewater-processing equipment. Filtrate having high electric conductivity may be supplied into the hopper 5. This structure enhances the electric conductivity of the sludge to be processed. The electric conductivity of the sludge between the anode units 21 to 25 and the cathode plate 4 is thus increased, leading to enhancement of dewatering performance. The moisture content of the dewatered sludge consequently decreases.

The conveyor belt 1 stops as illustrated in FIGS. 1a and 1b when the anode units 21 to 25 press the sludge while an electric current passes through the anode units 21 to 25. After the pressing by the anode units 21 to 25 for a certain time period with the flow of an electric current, air is discharged from the air cylinders of the anode units 21 to 25, thereby lifting the anode plates 33. The conveyor belt 1 rotates in a distance corresponding to a single pitch of the arrangement pitch of the anode units 21 to 25. Through this process, the sludge positioned below the anode unit 25 is discharged as the dewatered sludge, and the sludge positioned below the anode units 21 to 24 is transferred to the positions under the next anode units 22 to 25. Furthermore, the hopper 5 supplies non-dehydrated sludge to the position under the anode unit 21. The anode plates 33 of the anode units 21 to 25 move downward while an electric current passes between the anode units 21 to 25 and the cathode 4, thereby conducting the electro-osmotic dewatering of the sludge. These processes are repeated for the electro-osmotic dewatering of the sludge.

The coating 7, which is formed using a material having water permeability or electric conductivity on the lower surface 33a of the anode plate, prevents deposition of scale on the anode while securing the electric conductivity and maintaining the dewatering performance. The coating prevents or suppresses the following: particulate, anionic, or cationic scale components contained in the sludge move toward the surface of the anode and are deposited thereon.

The coating 7 is preferably formed using materials which have an affinity for the scale components and enable the scale component to be easily adsorbed.

The coating 7 formed using a material charged to a positive surface potential adsorbs negatively charged particulate or anionic scale components and avoids cationic scale components to prevent or suppress the movement thereof toward the anode.

The coating 7 formed using a material charged to a negative surface potential avoids negatively charged particulate or anionic scale components. The coating adsorbs cationic scale components to prevent or suppress the movement of the negatively charged particulate or anionic scale components toward the anode.

The coating 7 having a multilayered structure of a material charged to a negative surface potential and a material charged to a positive surface potential adsorbs or avoids negatively charged particulate, cationic, or anionic scale components, thereby preventing or suppressing the movement of these scale components toward the anode.

The coating 7 is preferably formed using materials having thermal resistance and acid resistance, for example, porous synthetic resins, especially, porous fluorine resins, such as a PTFE filter, or porous glass, such as a glass filter. Any other materials having water permeability or electric conductivity may be used.

In the case of using materials not having water permeability, materials which impart lower resistivity to the coating 7 are preferably used. The coating 7 has an electric resistivity of preferably 10⁻¹ Ωm or smaller, more preferably 10⁻³ Ωm or smaller. Since metal, such as stainless steel, titanium, and copper, is oxidized to be deteriorated or lose conductivity, non-metallic material, such as conductive films and conductive rubber, are preferably employed.

In the case of using materials having water permeability, water serves to secure electric conductivity, which enables the electric resistivity of the materials to be ignored.

The coating 7 preferably has smaller thickness. Preferred thickness is 10 mm or smaller, and more preferred thickness is in the range from 0.01 to 3 mm. The coating preferably has smaller pores. A preferred pore diameter is 10 μm or smaller, and more preferred pore diameter is in the range from 1 to 5 μm. In particular, open-cell type urethane or silicone sponge, non-woven fabric, or woven fabric is preferably employed.

In the case of using materials charged to a negative surface potential, since a pH level is small in the vicinity of the anode, materials having a negative electric potential at a pH level of seven or smaller are preferably employed. Preferred examples of such materials include woven or non-woven fabric of an alumina fiber or a glass fiber.

In the case of using materials charged to a positive surface potential, since a pH level is small in the vicinity of the anode, materials having a positive electric potential at a pH level of seven or smaller are preferably employed. Preferred examples of such materials include woven or non-woven fabric of a nylon fiber or a silk fiber.

A method for attaching the coating 7 to the anode is not specifically limited. The coating 7 may be directly attached to the anode or may be fixed as a result of being externally covered with a mesh 9 or other structures as illustrated in FIG. 4.

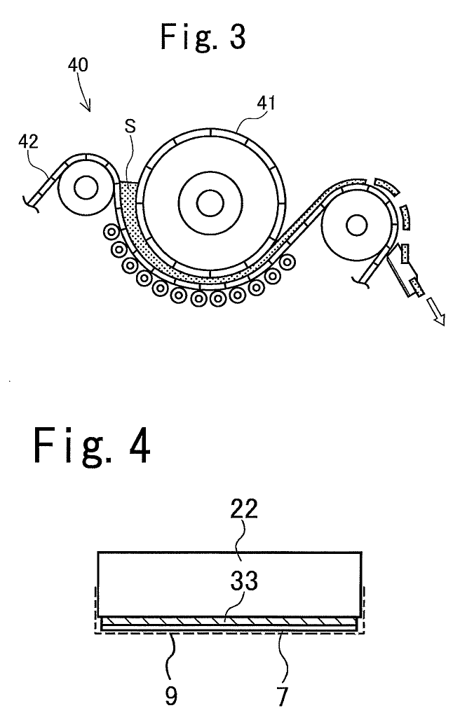

Although the electro-osmotic dewatering apparatus of the present embodiment includes the anode units 21 to 25, the conveyor belt 1, and the cathode 4 for the electro-osmotic dewatering of sludge, the invention can be also applied to other types of electro-osmotic dewatering apparatuses. For instance, as illustrated in FIG. 3, the invention may be applied to an electro-osmotic dewatering apparatus 40 in which the sludge S is pressurized between a drum-shaped anode 41 and a conveyor belt 42 which also functions as a cathode. Also in this case, a coating having at least any one of water permeability and electric conductivity is provided on the contact surface of the drum-shaped anode 41 with the sludge so as to surround the anode 41.

Although not illustrated, the invention can be applied to an electro-osmotic dewatering apparatus in which materials to be processed are pressurized between filter media. For example, as disclosed in Japanese Examined Patent Application Publication No. 7-73646 and Japanese Patent No. 3576269, the invention can be applied to a compressive electro-osmotic dewatering apparatuses in which sludge is pressurized between a pair of filter plates with a compressive film and electrode interposed therebetween.

In addition to the electro-osmotic dewatering, the invention can be used for, for example, the following applications.

1) Apparatus for Soda Electrolysis

An apparatus for electrolyzing salt into Cl₂ and NaOH is provided as an example. The invention may be applied to an apparatus for electrolyzing seawater to produce hypochlorous acid.

2) Apparatus for Producing Plating and Electrolytic Foil

An apparatus for electrolytically depositing ions contained in a solution on an anode or a cathode to form a plated layer or electrolytic foil. An apparatus for forming or producing copper plating, tin plating, zinc plating, aluminum foil, or copper foil is provided as an example.

3) Apparatus for Recovering Acid.Alkali.Salt

An apparatus for electrolyzing Na₂SO₄ and organic substances into sulfuric acid, caustic soda, and amino acid is provided as an example.

4) Electrodialyzer

An apparatus which includes a cation exchange membrane and an anion exchange membrane each disposed between an anode and a cathode and passes water between these membranes for deionization is provided as an example.

5) Apparatus for Producing Alkaline Ionized Water

An apparatus for electrolyzing water to produce alkaline ionized water.

6) Apparatus for Producing Hydrogen

An apparatus for electrolyzing KOH to produce hydrogen is provided as an example.

7) Electrocoagulation Apparatus

An apparatus for electrolyzing wastewater to coagulate SS.

### EXAMPLES

Examples and a comparative example are hereinafter described.

The electro-osmotic dewatering apparatus illustrated in FIGS. 1 and 2 was used for electro-osmotic dewatering of sludge generated in sewage treatment and having 80% moisture content. Operating conditions were as follows.

The number of anode units provided in the carrying direction of the conveyor belt: two

The rate of supplying sludge: 5 L/hr

Voltage to be applied to the anode units: 60V

### Example 1

Non-woven fabric was fixed to the under surface of the anode plate by a bolt, the non-woven fabric being formed using glass fibers and having a thickness of 0.7 mm, air permeability of 1.3 cm³/cm²/sec, and an average pore diameter of 1 μm. The electro-osmotic dewatering of the sludge was conducted under these conditions. Filtrate produced by the dewatering was completely transported to water treatment equipment. The dewatered sludge consequently had moisture content of 62 to 65%.

After the operation for 103 hours, scale components deposited on the anode units 21 and 22 were removed. The dry weight of the removed scale components was measured, which provided the result listed in Table 1.

### Example 2

Measurement was conducted as in Example 1 except that woven fabric formed using glass fibers and having a thickness of 0.33 mm and air permeability of 28 cm³/cm²/sec was used in place of the non-woven fabric of glass fibers. The measurement result is listed in Table 1.

### Example 3

Measurement was conducted as in Example 1 except that woven fabric formed using glass fibers and having a thickness of 0.25 mm and air permeability of 7 cm³/cm²/sec was used in place of the non-woven fabric of glass fibers. The measurement result is listed in Table 1.

TABLE 1

Amount of deposited scale
(g)

| | Moisture | Anode unit | Anode unit |
|---|---|---|---|
| | content (%) | 21 | 22 |
| Example 1 | 62-65 | 0.07 | 0.10 |
| Example 2 | | 0.16 | 0.09 |
| Example 3 | | 0.22 | 0.09 |
| Comparative | | 1.42 | 0.77 |
| example 1 | | | |

### Comparative Example 1

The electro-osmotic dewatering of the sludge was similarly conducted except that the non-woven fabric formed using glass fibers was not attached to the anode. The dewatered sludge consequently had moisture content of 62 to 65%. After operation for 126 hours, scale components deposited on the anode units 21 and 22 were removed. The dry weight of the removed scale components was measured, which provided the result listed in Table 1.

Table 1 demonstrates that Examples 1 to 3 involving the non-woven or woven fabric had the significantly small amount of deposited scale as compared with Comparative Example 1 without the coating, the non-woven or woven fabric being formed using glass fibers and coating the anode units.

Since the anode units coated with the non-woven or woven fabric formed using glass fibers were able to secure ability to pass an electric current, the dewatered sludge in Examples 1 to 3 had approximately the same moisture content as that in Comparative Example 1.

The invention has been described in detail with reference to the specific embodiment, it should be understood that the person skilled in art can variously modify the invention within the spirit and scope of the invention.

The invention contains subject matter related to Japanese Patent Application No. 2009-298233 filed in the Japanese Patent Office on Dec. 28, 2009, the entire contents of which are incorporated herein by reference.

1. An anode used for an apparatus for electrical treatment, the apparatus comprising the anode and a cathode facing the anode between which an object is treated by passing an electric current therethrough,
wherein the anode has a surface which the object contacts; and
wherein the surface is coated by a coating consisting of a material having at least one of water permeability and electric conductivity.

2. The anode used for an apparatus for electrical treatment according to claim 1, wherein the material consisting the coating further has acid resistance and thermal resistance.

3. The anode used for an apparatus for electrical treatment according to claim 2, wherein the coating is one of woven fabric and non-woven fabric formed using fibers.

4. The anode used for an apparatus for electrical treatment according to claim 2, wherein the fibers are glass fibers, and the coating has a thickness in the range from 0.01 to 10 mm.

5. The anode used for an apparatus for electrical treatment according to claim 2, wherein the coating is one of porous synthetic resin and porous glass.

6. The anode used for an apparatus for electrical treatment according to claim 1, wherein the material consisting the coating is a material charged to a negative surface potential.

7. An apparatus for electrical treatment, the apparatus comprising:
an anode; and
a cathode facing the anode between which an object is treated by passing an electric current therethrough,
wherein the anode is claim 1.

8. The apparatus for electrical treatment according to claim 7, wherein the electrical treatment is electro-osmotic dewatering.

9. A method for electrical treatment using the apparatus according to claim 7,
wherein the method comprising a step of placing an object to be treated consisting of one of liquid material and hydrated material between the anode and the cathode, and a step of applying a voltage between the anode and the cathode to pass an electric current thorough the object.
